(19) United States
(12) Patent Application Publication
(10) Pub. No.: US 2008/0016465 A1
(43) Pub. Date: Jan. 17, 2008

(54) PORTABLE ELECTRONIC DEVICE WITH GRAPHICAL USER INTERFACE

(75) Inventor: Eral Denis Foxenland, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/457,464

(22) Filed: Jul. 14, 2006

(51) Int. Cl. G06F 3/048

(52) U.S. Cl. 715/828; 715/810

(57) ABSTRACT

A portable electronic device and a method for accessing information in the electronic device, which includes a display and a graphical user interface for presentation of information on the display. The electronic device comprises a set of information items presentable in an item list on the display, such as a menu list, which set includes a first subset and a second subset. A user input interface is operable to select list items for activation, and a control unit is configured to present only the first subset responsive to a command on the user input interface to present the item list. The list is typically a vertical list which is longer than the display, and the first subset is a number of most important items within the list. Moving a highlight beyond an endpoint item of the first subset may trigger the control unit to unfold the full list. The list may be a menu in which the first subset contains the most frequently used items, or the list may be a text of which the first subset is an abstract or an introduction.

### FIELD OF THE INVENTION

The present invention relates generally to graphical user interfaces presentable on displays of compact portable electronic devices, such as mobile phones, and offers an improved solution for displaying and navigating in menus in a comprehensible manner.

### BACKGROUND

Since the end of the 20^{th} century the cellular telephone industry has had enormous development in the world. The first commercially attractive cellular telephones or mobile phones were introduced in the market at the end of the 1980's. Since then, a lot of effort has been made in making smaller mobile phones, with much help from the miniaturization of electronic components and the development of more efficient batteries. Today, numerous manufacturers offer pocket-sized mobile phones with a wide variety of capabilities and services, such as packet-oriented transmission and multiple radio band coverage.

The development in electronics has come to the point where a further miniaturization of the mobile phones might cause some drawbacks—not the size itself but the capability to handle the keypad and reading the display. However, the display has in fact become larger and larger at the same time as the size of the total mobile phone has decreased. Many state of the art mobile mobile phones are similar to small pocket computers known as personal digital assistants (PDA), with only few buttons or keys and a large display substantially covering the entire front side of the mobile phone. In any case, the mobile phone display will still be quite small and therefore not suitable for presentation of large volumes of data. Still, already today the mobile phones are quite capable and have a lot of technical functions and can be used for many different services. In order to navigate through the different options and actions that are selectable, the mobile phones are generally devised with some form of menu information system. When browsing through such menus more text than fits the screen must generally still be viewed. Furthermore, in many cases the menu items themselves are sub-menus in which further browsing can be made. When the display is very small, which would still be the case even if the display would cover the entire front-side of the phone, it is not possible to expand menus horizontally more than maybe a few pixels. Most menus for portable mobile phones therefore expand vertically or open up into a whole new screen mode.

As technology progresses, the mobile phones become more and more advanced. Today, a mobile phone is not just a means for voice communication. Built-in media players, such as mp3 players allow the mobile phones to be used as music players, and high resolution cameras makes it possible to capture and store high quality images and to perform video conferencing. Mobile television is already offered in several countries, and is likely to become a widely used service within short. Pocket-size mobile phones are therefore crowded with different functionalities which are controllable by means of a fairly limited user interface. A common approach is to make use of the display together with navigation tools and soft keys, to make it easy for the user to understand how to access different functions. Still, the more icons and information you present simultaneously on the display, the more confusing things tend to become.

### SUMMARY OF THE INVENTION

Consequently it is an object of the present invention to overcome the above-identified deficiencies related to the identified field and to the prior art thereof. More specifically, it is an object of the invention to provide an improved solution for arranging lists comprising a plurality of list items for presentation on a display on a compact portable electronic device.

According to a first aspect of the invention, this object is fulfilled by a portable electronic device including a display and a graphical user interface for presentation of information on the display, comprising:
a set of information items presentable in an item list on the display, which set includes a first subset and a second subset;
a user input interface;
a control unit configured to present only the first subset responsive to a command on the user input interface to present the item list.

In one embodiment the item list is a vertical list which is longer than the display.

In one embodiment the control unit is configured to present the second subset as extension to the first subset responsive to detection of a command to present the second subset.

In one embodiment the user input interface comprises a navigation tool operable to move a highlight between presented list items.

In one embodiment the user input interface comprises a navigation tool operable to trigger the control unit to present the second subset by moving a highlight beyond an endpoint list item of the first subset.

In one embodiment the control unit is configured to present an extension indication, and to present the second subset of items responsive to user activation of the extension indication.

In one embodiment the control unit is configured to present an extension indication, and to present a scrollbar operable to scroll through the items of the list responsive to user activation of the extension indication.

In one embodiment the control unit is configured to present an extension indication, operable to present the second subset of items by moving the highlight to the extension indication.

In one embodiment the portable electronic device comprises:
a timer function, wherein the control unit is configured to hide the second subset of items after a predetermined time period without user interaction.

In one embodiment the first subset of items includes a selected number of higher priority items within the list of items.

In one embodiment the first subset of items includes a number of most used items within the list of items.

In one embodiment the first subset of items comprises a summary or introduction portion of more extensive information provided in the second subset of items.

In one embodiment the list of items is a menu list, and each item is a menu item.

According to a second aspect, the stated object is fulfilled by means of a method for accessing information in a portable electronic device, comprising the steps of:
entering a command to present a list including a number of list items on a display of the device;
presenting a first subset of items on the display and hiding a second subset of menu items;
entering a command to present the second subset on the display;
presenting the second subset of menu items.

In one embodiment the item list is a vertical list which is longer than the display.

In one embodiment the step of presenting the second subset includes presenting the second subset as extension to the first subset responsive to detection of a command to present the second subset.

In one embodiment the step of entering a command to present the second subset includes moving a highlight beyond an endpoint list item of the first subset.

In one embodiment the step of entering a command to present the second subset includes activating an extension indication.

In one embodiment the step of presenting the second subset includes presenting a scrollbar operable to scroll through the items of the list responsive to user activation of the extension indication.

In one embodiment the method comprises the step of:
hiding the second subset of items after a predetermined time period without user interaction.

In one embodiment the first subset of items includes a selected number of higher priority items within the list of items.

In one embodiment the first subset of items includes a number of most used items within the list of items.

In one embodiment the first subset of items comprises a summary or introduction portion of more extensive information provided in the second subset of items.

### BRIEF DESCRIPTION OF THE DRAWINGS

The features and advantages of the present invention will be more apparent from the following description of the preferred embodiments with reference to the accompanying drawings, on which

FIGS. 1 and 2 schematically illustrate portable electronic devices according to two different embodiments;

FIG. 3 schematically illustrates a block diagram of a graphical user interface system for use in a portable electronic device according to an embodiment of the invention;

FIG. 4 illustrates how a first subset of a list is illustrated on a display screen according to an embodiment of the invention; and

FIG. 5 illustrates the unfolded full list including both the first subset and a second subset.

### DETAILED DESCRIPTION OF PREFERRED EMBODIMENTS

The present description relates to the field of portable electronic devices comprising displays for presenting information. In a preferred embodiment, the invention relates to mobile phones, but other embodiments are also within the scope of the invention, such as portable compact computers, digital cameras, portable media players, and so on. Common for such portable electronic devices is that they include a number of functions which may be accessed by means of browsing in menu lists presented on the display. Furthermore, it should be emphasized that the term comprising or comprises, when used in this description and in the appended claims to indicate included features, elements or steps, is in no way to be interpreted as excluding the presence of other features elements or steps than those expressly stated.

Exemplary embodiments will now be described with references made to the accompanying drawings.

FIG. 1 illustrates a first embodiment of an electronic device in the form of a mobile phone 10, in which the present invention may be employed. It should be noted that the elements indicated in the drawings do not necessarily have to be physically divided in the manner shown, and that the outer appearance of the mobile phone need not take the indicated shape of FIG. 1. Instead the mobile phone may e.g. be of a clamshell type, a jack knife type, or the like. The phone 10 includes a user interface comprising an input part, preferably including a set of keys 11, and additionally or optionally a touch-sensitive functionality on a display 12. An output part of the user interface includes display 12 for presenting information to a user. For the purpose of conducting speech communication, mobile phone 10 further preferably includes a microphone 13 and a speaker 14. Besides speaker 14, an additional speaker (not shown) may be employed inter alia for the purpose of providing alert signals to a mobile phone user, and as a loudspeaker. Otherwise, or in addition, speakers for presenting audio, such as music, to a user are typically provided in the form of a headset which is communicatively connectable to the media player. A support structure including a chassis and a cover 15 supports the other components of the mobile phone 10. The actual function of mobile phone 10 as a mobile phone is not crucial to the invention, and will therefore not be described in detail. However, the mobile phone 10 further comprises a radio transceiver system including an antenna for use in one or more radio bands. A control unit, preferably a microprocessor system with associated memory space and operation software, is configured to control the functions of the phone. As a power supply, mobile phone 10 preferably further includes a battery.

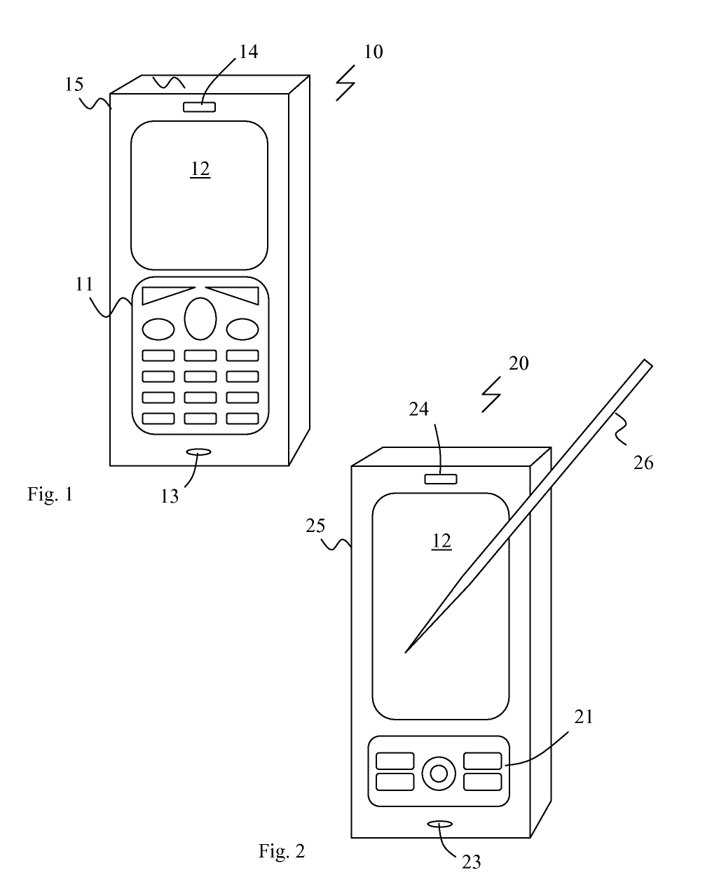

FIG. 2 illustrates an alternative embodiment. Electronic device 20 has a smaller input interface 21, which means that the display 22 can be made larger, or alternatively the total device 20 may be smaller. The electronic device 20 is to a large extent operated by means of input detection using a touch-sensitive display 22, and potentially a stylus 26 for more accurate operation than a fingertip. A support structure 25 carried the components of the device 20. Electronic device 20 may also be a mobile phone, in which case a microphone 23 and a speaker 24 are also included, but is alternatively a pocket computer, game console, a digital camera, or the like.

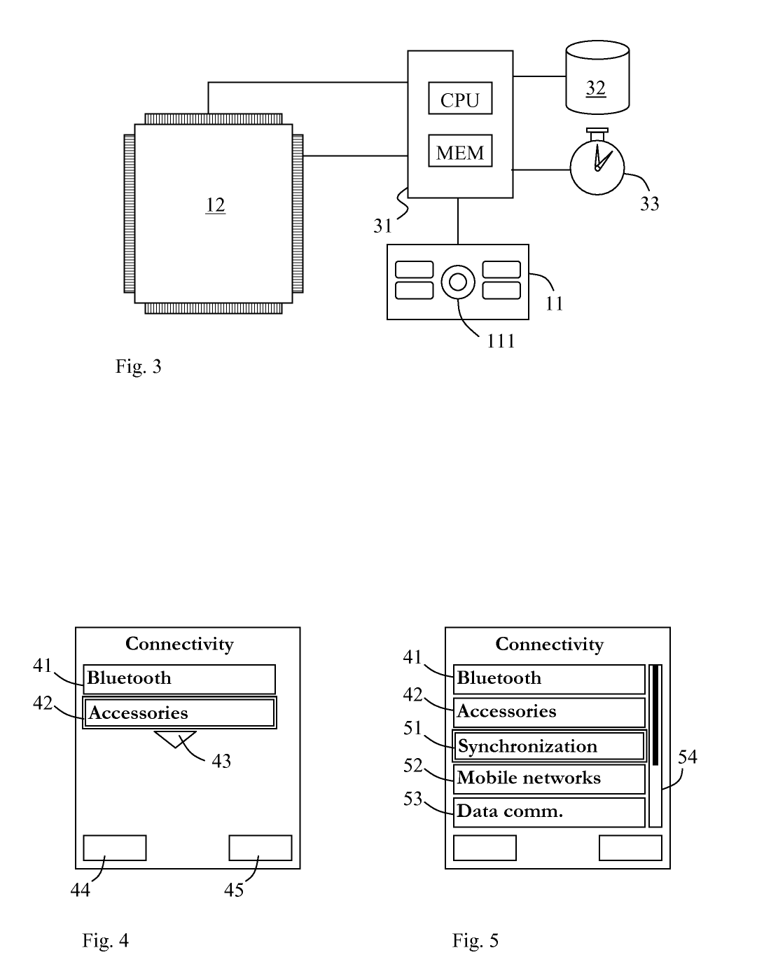

FIG. 3 schematically illustrates a graphical user interface system, for use in an electronic device according to an embodiment of the invention. A display 12 is communicatively connected to microprocessor unit 31, which in turn includes at least a computer processor CPU and an internal memory MEM. The hardware of the microprocessor unit is further associated with a computer program product comprising software for handling the presentation of information on the display 12, by use of a graphical user interface. In order to input data to the microprocessor unit 31, an input interface 11 is included. The input interface 11 preferably includes a set of keys and a navigation tool 111 (or 211 as in FIG. 2) for moving a cursor over the display or for moving a highlight between selectable options presented on the display. The navigation tool may be a joystick, a trackball, a slide pad, or a set of arrow keys. /or a cursor control device 24 such as a mouse, a track ball or a joy stick. The microprocessor unit 31 is further connected to a memory or database 32, containing data for presentation on display 12. In the embodiment of the electronic device 10 as a mobile phone, memory 32 may be or correspond to a subscriber identification module SIM connectable to the mobile phone.

The function of the invention will now be described with reference to the display screens shown in Figs . . . , where the display as such forms part of an electronic device such as device 10 or 20.

The basic objective is to show more information than actually fits the display screen. As an example, a menu list containing a number of menu items is to be presented. In order for each item to be clearly visible and readable, a certain minimum font size has to be used for the letters of the menu item labels. A consequence thereof is that it may not be able to show all items at once. Instead, the user may scroll up and down the menu list using the navigation tool 111 or optionally a scrollbar displayed on the screen. As display technology progresses, larger displays have become affordable and may well be up to several inches high on a portable electronic device today. Still, it is an overall market desire to maintain the compact size of the portable device as such, which puts a constraint on how large the display can be. It will therefore still be preferable to use scrollable lists in portable compact electronic devices when the full lists does not fit the display screen. Another issue is the tendency to include more and more features and functions in the portable devices. While the display increases and the compact size is maintained, the input interface comprising keys and buttons are often minimized. Again, this means that the display as such is used to a larger extent to navigate through menus for the different functions of the device, since fewer special keys are included. The increasing amount of functions also means that the amount of information presented to the user increases. However, there is only so much information that can be processed by a user, and excessive presentation of information tends to confuse the user rather than serve as a helpful tool.

It is within this context the inventor has realized that a way of assisting the user is to limit the amount of information to present, by suppressing certain parts of presentable lists. By adding an indication that more information or list items are available, the user may unfold also the hidden parts to get access to the suppressed parts if needed. However, in most cases only a fraction of all options provided in a displayed list are actually used on a day to day basis.

In FIG. 4 a screen of display 12 is shown. The user of device 10 has made an input selection, preferably by operating the input interface 11, to enter a Connectivity menu. The Connectivity menu is a list containing a plurality of different list items, or menu items. However, most of these menu items are rarely used, whereas only a few are more or less frequently used. For this reason, the information stored in memory 32, to be presented as items in the list, is divided into two subsets of items. A first subset is configured to contain higher priority items, and the second subset is configured to contain the items or relatively lower priority. The definition of which items are of higher or lower priority may be determined as a setting from the factory, or from the network operator. Alternatively, the user is allowed to set the relevance of each menu items, to either be of higher or lower priority. As yet another alternative, a timer function 33 is configured to determine the time passed since the last selection of each menu item, and to list the menu items in the list in descending order so that the most frequently used menu items are placed highest, i.e. with highest priority.

In the example of FIG. 4, the full Connectivity list comprises the items:

### Bluetooth;

### Accessories;

### Synchronization;

### Mobile networks;

### Data communication;

### Internet settings;

### Streaming settings;

### Settings for Java™;

### Infrared port.

However, most of these are rarely used by the common mobile phone user. In this example, it has been decided that only two of these are of higher priority, namely Bluetooth and Accessories. Again, this may be a factory or operator setting, a user setting, or an automatic setting. In any case, the functions or information behind the other items are presumed to be less often selected by the user. Therefore, Bluetooth 41 and Accessories 42 are configured to form the first subset of items, and the remaining items are configured to belong to the second subset of items. When the Communication menu is called upon, the screen as shown in FIG. 4 appears, where only the items of the first subset are shown, and the items of the second subset are hidden. Any one of these two items may be selected by activation, either leading to a new submenu, to presentation of information, or to the triggering of an action. Selection of an item may be performed by using navigation tool 111 for moving a highlight, such as frame, an enlargement of the item text, a color change or similar, as is well known within the field of display-presentable menus. alternatively, a cursor may be navigated to any one of the items 41 or 42 for selection. In FIG. 4, item 42 is currently highlighted by means of a double line frame, as an example. Soft keys 44 and 45 may also be presented, with different text for different items according to the established art.

Obviously the list in question contains more than the two presented items 41 and 42. In one embodiment, an indication 43 is presented below the lowermost presented higher priority item 42 as illustrated. A similar indication, may be presented above the uppermost presented item 41. Indication 43 serves to notify the user that there are more items in the list, which may also be accessed. In a preferred embodiment, moving a highlight down from the lowermost presented item 42 triggers control unit 31 to unfold the entire list. Preferably, no particular activation by pressing the navigation tool or any other key is necessary, the mere transportation of the highlight passed to lowermost, or uppermost, presented higher priority item opens up the entire list. In one embodiment, the indication 43 is dispensed with. Still, moving the highlight beyond the presented items, i.e. upwards from item 41 or downwards from item 42, unfolds the full list. When the full list is unfolded, moving the highlight beyond an endpoint item preferably moves the highlight to the opposite end point item of the list. This is preferably also the case if the menu in question is small, and therefore all items are presented directly without hiding any items.

FIG. 5 schematically illustrates the unfolded full list, in which a number 51, 52 and 53 of the remaining items are also presented. Preferably, unfolding of the full list by operating the navigation tool 111 downwards places the second subset immediately below the first subset as an extension thereof, with the highlight placed on the first item 51 of the second subset, as shown in the example of FIG. 5. This way, the second subset will be a natural extension of the first subset. When the list is unfolded, and if the list is larger than what can fit on the screen, control unit 31 is preferably configured to present a scrollbar 54 upon unfolding of the full list. In one embodiment, timer function 33 is also used for folding of the menu. In case no user interaction is detected, i.e. no scrolling and no key pressing, within a certain period of time, the menu is automatically folded again. That period of time may e.g. be in the range of 5-30 seconds or even within the range of 10-25 seconds. Preferably, control unit 31 is only configured to fold the menu list if the highlight is presently placed on one of the higher priority items 41 or 42.

Another embodiment involves a list which is an information text or even a literary piece. In this embodiment, the first subset includes an abstract or introduction portion of the full text. The abstract or introduction portion is configured to occupy no more than one screen, such that the full abstract or introduction portion of the first subset can be seen at once. An indication similar to the arrow-like indication 43 may or may not be included. In any case, operating the navigation tool either up or down when the first subset is shown opens up the second subset. In one embodiment, the first subset is then hidden and only the second subset is shown, which may be the case if the first subset is an abstract. If the first subset is an introduction portion, operation of the navigation tool may lead to the presentation of both subsets. Again, a scrollbar is preferably also presented upon unfolding the second subset.

Needless to say, there may well be more than two subsets, i.e. three or more, in both the latter embodiment and the embodiment described with reference to FIGS. 4 and 5, with equally many priority levels.

A benefit with the invention is that the presentation of information and selectable choices is minimized, which most often makes it easier for a user to find the information or commands sought for. Even if a most commonly used menu item is placed at the very beginning of a menu, the presentation of a long list tends to clutter the screen, and the more information shown simultaneously on the screen, the higher the risk is that you actually miss what you are looking for since there is an automatic tendency to read faster. By leaving out items which are rarely used, the ones of higher interest can be presented alone. Furthermore, the expansion or unfolding of the list is performed with mere up or down actuation of the navigation tool, which makes the mobile phone easier to handle. The effect of the invention is therefore ease of use for the mobile phone user, who generally is of less than average technical skill.

The foregoing has described the principles, preferred embodiments and modes of operation of the present invention. However, the invention should not be construed as limited to the particular embodiments discussed. Instead, the described embodiments should be regarded as illustrative rather than restrictive, and it should be appreciated that variations may be made in those embodiments by persons skilled in the arts without departing from the scope of the present invention as defined by the following claims.

I claim:

1. A portable electronic device including a display and a graphical user interface for presentation of information on the display, comprising:
a set of information items presentable in an item list on the display, which set includes a first subset and a second subset;
a user input interface;
a control unit configured to present only the first subset responsive to a command on the user input interface to present the item list.

2. The portable electronic device of claim 1, wherein the item list is a vertical list which is longer than the display.

3. The portable electronic device of claim 1, wherein the control unit is configured to present the second subset as extension to the first subset responsive to detection of a command to present the second subset.

4. The portable electronic device of claim 1, wherein the user input interface comprises a navigation tool operable to move a highlight between presented list items.

5. The portable electronic device of claim 1, wherein the user input interface comprises a navigation tool operable to trigger the control unit to present the second subset by moving a highlight beyond an endpoint list item of the first subset.

6. The portable electronic device of claim 1, wherein the control unit is configured to present an extension indication, and to present the second subset of items responsive to user activation of the extension indication.

7. The portable electronic device of claim 1, wherein the control unit is configured to present an extension indication, and to present a scrollbar operable to scroll through the items of the list responsive to user activation of the extension indication.

8. The portable electronic device of claim 2, wherein the control unit is configured to present an extension indication, operable to present the second subset of items by moving the highlight to the extension indication.

9. The portable electronic device of claim 1, comprising:
a timer function, wherein the control unit is configured to hide the second subset of items after a predetermined time period without user interaction.

10. The portable electronic device of claim 1, wherein the first subset of items includes a selected number of higher priority items within the list of items.

11. The portable electronic device of claim 1, wherein the first subset of items includes a number of most used items within the list of items.

12. The portable electronic device of claim 1, wherein the first subset of items comprises a summary or introduction portion of more extensive information provided in the second subset of items.

13. The portable electronic device of claim 1, wherein the list of items is a menu list, and each item is a menu item.

14. Method for accessing information in a portable electronic device, comprising the steps of:
entering a command to present a list including a number of list items on a display of the device;
presenting a first subset of items on the display and hiding a second subset of menu items;
entering a command to present the second subset on the display;
presenting the second subset of menu items.

15. The method of claim 14, wherein the item list is a vertical list which is longer than the display.

16. The method of claim 14, wherein the step of presenting the second subset includes presenting the second subset as extension to the first subset responsive to detection of a command to present the second subset.

17. The method of claim 14, wherein the step of entering a command to present the second subset includes moving a highlight beyond an endpoint list item of the first subset.

18. The method of claim 14, wherein the step of entering a command to present the second subset includes activating an extension indication.

19. The method of claim 14, wherein the step of presenting the second subset includes presenting a scrollbar operable to scroll through the items of the list responsive to user activation of the extension indication.

20. The method of claim 14, comprising the step of:
hiding the second subset of items after a predetermined time period without user interaction.

21. The method of claim 14, wherein the first subset of items includes a selected number of higher priority items within the list of items.

22. The method of claim 14, wherein the first subset of items includes a number of most used items within the list of items.

23. The method of claim 14, wherein the first subset of items comprises a summary or introduction portion of more extensive information provided in the second subset of items.
